(19) United States
(12) Patent Application Publication
(10) Pub. No.: US 2025/0192209 A1
(43) Pub. Date: Jun. 12, 2025

(54) HYDROGEN CONSUMPTION SYSTEM

(71) Applicant: TOYOTA JIDOSHA KABUSHIKI KAISHA, Toyota-shi Aichi-ken (JP)

(72) Inventor: Koji SUGIURA, Toyota-shi Aichi-ken (JP)

(73) Assignee: TOYOTA JIDOSHA KABUSHIKI KAISHA, Toyota-shi Aichi-ken (JP)

(21) Appl. No.: 18/945,046

(22) Filed: Nov. 12, 2024

(30) Foreign Application Priority Data
Dec. 8, 2023 (JP) 2023-207572

(51) Int. Cl. H01M 8/04746; H01M 8/04082; H01M 8/0438

(52) U.S. Cl. CPC H01M 8/04753; H01M 8/04201; H01M 8/04388

(57) ABSTRACT

A plurality of detachable hydrogen tanks, a fuel cell for consuming hydrogen by hydrogen is supplied, a hydrogen supply pipe flowing hydrogen is connected to the hydrogen tank and the fuel cell, and a hydrogen consumption system having a control device, the hydrogen tank has an on-off valve in the connection portion between the supply pipe, the supply pipe is provided with a push rod to the connection portion between the hydrogen tank, the control device is a hydrogen tank for supplying hydrogen from a plurality of hydrogen tanks and a hydrogen tank that does not supply hydrogen, the hydrogen tank for supplying hydrogen is moved toward the push rod to the on-off valve and a connection position capable of supplying hydrogen to the supply pipe, to move the push rod to the hydrogen tank that does not supply hydrogen is a standby position.

### CROSS-REFERENCE TO RELATED APPLICATIONS

This application is based upon and claims the benefit of priority of the prior Japanese Patent Application No. 2023-207572, filed on Dec. 8, 2023, the entire contents of which are incorporated herein by reference.

### FIELD

The present disclosure relates to a system for consuming hydrogen, which is a supplied fuel.

### BACKGROUND

Patent Document 1 discloses that, in a hydrogen storage unit, a plurality of hydrogen tanks are mounted on a manifold, hydrogen is filled into a plurality of tanks via a manifold, and hydrogen is supplied from a plurality of tanks via a manifold.

### CITATION LIST

### Patent Literature

Patent Literature 1: JP 2016-157522 A

### SUMMARY

### Technical Problem

In a system in which a plurality of tanks are connected at the same time, when there are a tank for supplying hydrogen and a tank for not supplying hydrogen, it has not been possible to properly use, such as supplying hydrogen with only an arbitrary tank. Therefore, hydrogen may flow into a tank that does not supply hydrogen.

In view of the above problems in the present disclosure, in the hydrogen consumption system in which a plurality of hydrogen tanks are mounted, it is possible to use the hydrogen tank more easily.

### Solution to Problem

The present application, a plurality of detachable hydrogen tanks, a fuel cell for consuming hydrogen by hydrogen is supplied, a hydrogen supply pipe flowing hydrogen is connected to the hydrogen tank and the fuel cell, and a hydrogen consumption system having a control device, the hydrogen tank has an on-off valve in the connection portion between the supply pipe, the supply pipe is provided with a push rod to the connection portion between the hydrogen tank, the control device is a hydrogen tank for supplying hydrogen from a plurality of hydrogen tanks and a hydrogen tank that does not supply hydrogen, the hydrogen tank for supplying hydrogen is moved toward the push rod to the on-off valve and a connection position capable of supplying hydrogen to the supply pipe, to move the push rod to the hydrogen tank that does not supply hydrogen, the closed valve condition but the on-off valve and the supply pipe is a standby position to maintain the airtightness in a state of being connected, discloses a hydrogen consumption system.

The control device acquires the hydrogen remaining amount of the plurality of hydrogen tanks by the sensor, when the determination of sorting, the hydrogen remaining amount is the smallest hydrogen tank only controlled so that the connection position, other hydrogen tanks may be controlled so as to be in the standby position.

### Effects

According to the present disclosure, in the hydrogen consumption system in which a plurality of hydrogen tanks are mounted, even if there is a hydrogen tank that supplies hydrogen, the hydrogen tank that does not supply hydrogen, that is closed while communicating with the supply pipe in a high-pressure state, the hydrogen from the hydrogen tank used is not flow, it is possible to use the hydrogen tank properly.

### BRIEF DESCRIPTION OF DRAWINGS

FIG. 1 is a diagram showing the configuration of a hydrogen consumption system 10.

FIG. 2 is an external view showing the configuration of the hydrogen tank 11.

FIG. 3 is a cross-sectional view showing the configuration of the hydrogen tank 11.

FIG. 4 is a diagram for explaining the on-off valve 15 and the connecting device 23.

FIG. 5 is a diagram illustrating a control device 50.

FIG. 6 is a diagram for explaining the connection of the on-off valve 15 and the connecting device 23.

FIG. 7 is a diagram illustrating the flow of the hydrogen-supply control S10.

FIG. 8 is a view illustrating another connection position;

FIG. 9 is a view illustrating another standby position.

### DESCRIPTION OF EMBODIMENTS

### 1. Hydrogen Consumption System

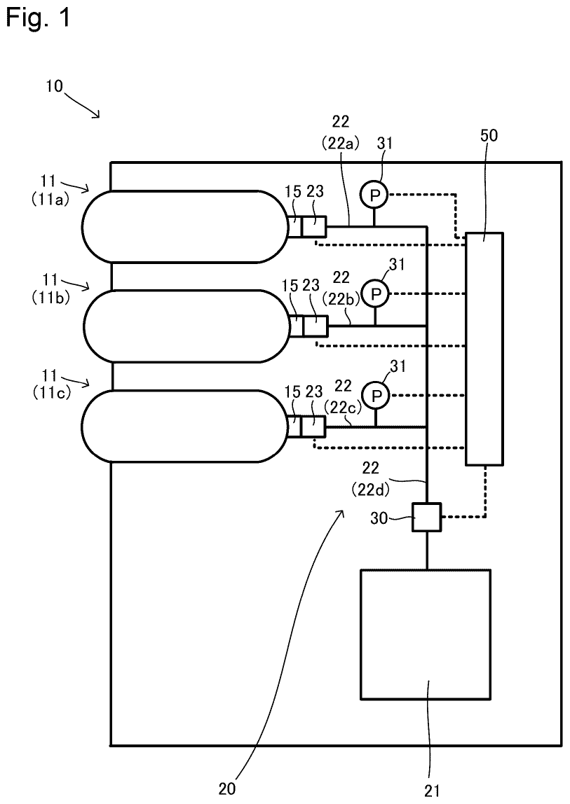

FIG. 1 conceptually shows the configuration of the hydrogen consumption system 10 according to one form. Such a hydrogen consumption system 10 has a hydrogen tank 11 which is a source of hydrogen, a hydrogen consumption apparatus 20 which is a supply destination of the hydrogen, and a control device 50. Hydrogen consumption system 10 of the present embodiment is a system for generating electricity by supplying hydrogen stored in the hydrogen tank 11 to the fuel cell 21 included in the hydrogen consuming apparatus 20. In addition, in the present embodiment, the hydrogen tank 11 is configured to be capable of being attached and detached to and from the hydrogen consumption apparatus 20

It will be described in more detail below for.

### 1.1. Hydrogen Tank

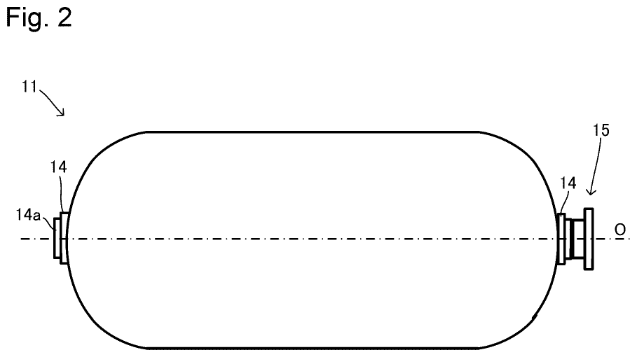

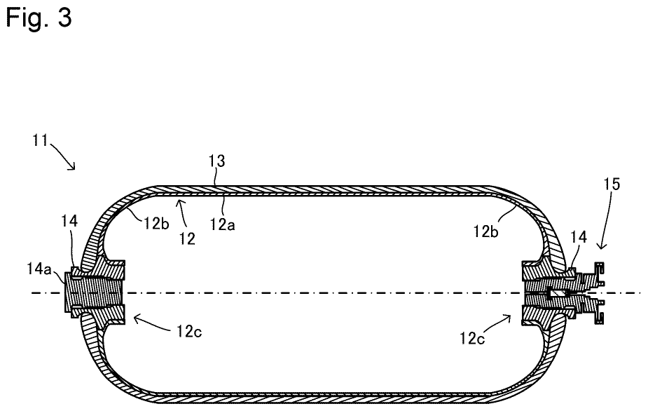

The hydrogen tank 11 is a container in which fuel to be supplied (hydrogen in this form) is stored in a liquid state or a gaseous state. FIG. 2 and FIG. 3 showed the figure for an explanation. FIG. 2 is an external view, FIG. 3 is a sectional view taken along the direction of the axis O of the tank 11. As can be seen from these figures, the hydrogen tank 11 in this form has a liner 12, the reinforcing layer 13, the mouthpiece 14, and the on-off valve 15. Each configuration will be described below.

### 1.1.1. Liner

The liner 12 is a hollow member which partitions the internal space of the hydrogen tank 11, and is cylindrical in this form. Liner 12, the opening at both ends of the fuselage 12a diameter is substantially constant is narrowed by the dome-shaped side-end 12b, the cap 14 is disposed in the narrowed opening 12c.

It is sufficient that the liner 12 is made of a material capable of retaining (e.g., hydrogen) contained in its internal space without leaking, and a known material can be used as the material. Specifically, for example, a nylon resin, a polyethylene-based synthetic resin, or made of a metal such as stainless steel or aluminum. In some embodiments, the material constituting the liner is a synthetic resin from the viewpoint of weight reduction of the tank.

The thickness of the liner 12 is not particularly limited, but in some embodiments is 0.5 mm˜3.0 mm.

### 1.1.2. Reinforcement Layer

In the reinforcing layer 13, fibers are laminated over a plurality of layers, and a cured resin is impregnated into the fibers. A layer made of fibers is formed by winding a fiber bundle over a plurality of layers to a predetermined thickness on an outer periphery of a liner 12 Although the thickness of the reinforcing layer 13 and the number of turns of the fiber bundle are determined by the required strength, they are not particularly limited, but are of a 10 mm˜30 mm degree.

### <Fiber Bundle>

For example, carbon fibers are used for the fiber bundle of the reinforcing layer 13, and the fiber bundle has a band shape in which carbon fibers form a bundle and have a predetermined cross-sectional shape (e.g., a rectangular cross section). Although not particularly limited, there may be mentioned a rectangular shape having a 6 mm˜20 mm cross section and a 0.1 mm˜0.3 mm thickness. The amount of carbon fibers contained in the fiber bundle is not particularly limited, and examples thereof include a carbon fiber of about 36000.

### <Impregnated Resin>

The resin impregnated and cured in the fiber (fiber bundle) in the reinforcing layer 13 is not particularly limited as long as it can increase the strength of the fiber by this. Examples thereof include a thermosetting resin which is cured by heat, and specific examples thereof include an amine-based or anhydride-based curing accelerator and an epoxy resin containing a rubber-based reinforcing agent, an unsaturated polyester resin, and the like. In addition, a resin composition containing an epoxy resin as a main agent and cured by mixing a curing agent thereto can be also mentioned. According to this, it is automatically cured by allowing the resin composition which is the mixture to reach and penetrate the fiber layer between the time when the main agent and the curing agent are mixed and cured.

### <Protective Layer>

If necessary, a protective layer may be disposed on an outer periphery of the reinforcing layer. When provided, for example, glass fibers are wound and impregnated with a resin. The resin to be impregnated can be considered similarly to the reinforcing layer 12 Thus, impact resistance can be imparted to the hydrogen tank 11.

Although there is no particular limitation on the thickness of the protective layer, it may be a 1.0 mm˜1.5 mm degree.

### 1.1.3. Mouthpiece

Mouthpiece 14 is a member which is attached to each of the two opening 12c of the liner 12 is disposed at each of the axial lines O of the liner 12, and functions as an opening communicating the inside and outside of the hydrogen tank 11, on one of which the on-off valve 15 is attached. Thus the mouthpiece 14, the cross section for the on-off valve 15 is disposed a circular hole is provided. The inner surface of the hole is provided with a female screw corresponding to the male screw of the on-off valve 15. The on-off valve 15 is fixed to the mouthpiece 14 by combining with the male screw of the on-off valve 15 to the female screw. Further, the inner surface of the hole has a sealing surface which is a smooth surface on the tank inside (high pressure side) than the female thread. The seal member provided on the outer periphery of the on-off valve 15 on the sealing surface is in contact with the inside of the hydrogen tank 11 airtight (seal) is made.

The member constituting the mouthpiece 14 is not particularly limited as long as it has the necessary strength, and examples thereof include stainless steel and aluminum.

### 1.1.4. Open/Close Valve

The on-off valve 15 is held in the hole of the mouthpiece 14 so as to pass the inside and outside of the hydrogen tank 11. The on-off valve 15 is disposed on one of two mouthpieces 14 provided at both longitudinal ends of the hydrogen tank 11. Incidentally, the mouthpiece 14 on the other side is sealed with a stopper 14a is disposed.

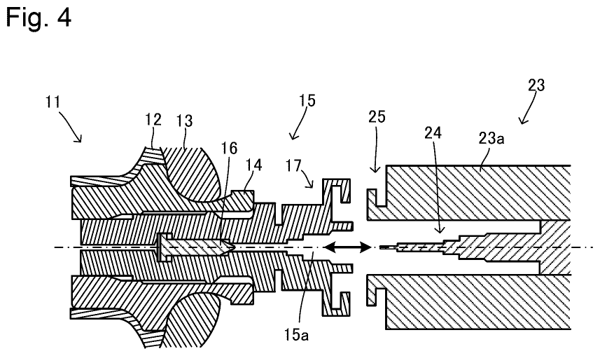

In FIG. 4 is a diagram including the vicinity of the on-off valve 15 of FIG. 3 shows a diagram of a state in which the connection device 23 of the gas consumption apparatus 20 to be described later on the on-off valve 15 is separated. The on-off valve 15 has a shaft portion disposed inside the hole of the mouthpiece 14 is provided with a male screw which is combined with the female screw of the mouthpiece 14 on the outer peripheral surface of the shaft portion, whereby the on-off valve 15 is fixed to the hole of the mouthpiece 14. Further, the outer peripheral surface of the on-off valve 15 is disposed a seal member (not shown), the seal member is disposed so as to contact the seal surface of the inner surface of the hole of the mouthpiece 14 airtight (seal) is made.

The on-off valve 15 is provided with a hole 15a leading to the valve body 16, the operation of the on-off valve 15 is performed by the push rod 43 is inserted here.

The on-off valve 15 has a valve body 16, and a connecting portion 17.

### <Valve Element>

The valve element 16 is a switching valve for permitting and regulating the communication of the inside and outside of the hydrogen tank 11. In this form, the valve element 16 is biased so as to restrict the communication when the valve is closed, the valve element 16 by pressing against the urging force of the valve element 16 is moved to allow the communication. Thus in this form to switch the communication by pressing and releasing the valve element 16, it is necessary for pressing the valve element 16. Therefore, a push rod, as described later, for pressing the valve body 16 to the hydrogen consuming apparatus 20 is provided. By performing the opening and closing of the valve element 16 in the hydrogen consuming apparatus 20 side, it is not necessary to control by electrically connecting the hydrogen tank 11 to the control device 50 for detaching, it is possible to perform control by the control device 50 more reliably.

### <Connection Part>

The on-off valve 15, the side connected to the hydrogen consuming apparatus 20 has a connecting portion 17 connected to the hydrogen consuming apparatus 20. In the connecting portion 17 is a portion capable of engaging and disengaging the connecting portion 25 of the connecting device 23 of the connecting portion 17 and the hydrogen consuming apparatus 20. The specific aspect is not limited, but a mechanical coupling (mechanical interface) can be exemplified in the present embodiment, among which a mount such as connecting a photographing lens to the main body in the camera can be applied, and more specifically, it is possible to use the C mount.

### 1.1.5. Other

The allowable pressure of the hydrogen tank 11 is not particularly limited, but may include a tank capable of storing hydrogen at an allowable pressure of 70 MPa or less beyond 20 MPa from the viewpoint of supplying more hydrogen while being small to maintain portability.

In this form, a plurality of hydrogen tanks 11 are provided (e.g., 3), and each hydrogen tank 11 is filled with hydrogen. Here, three hydrogen-tank 11 are arranged, and the sign is expressed in 11a, 11b, 11c in order to distinguish them. All of these hydrogen tanks 11 may have the same capacity, or tanks of different capacities may be included.

### 1.2. Hydrogen Consumption Device

The hydrogen consuming apparatus 20 is a supply destination of hydrogen in the hydrogen tank 11, and is a device which receives hydrogen and consumes it. Hydrogen consumption apparatus 20 in this form, as shown in FIG. 1, the fuel cell 21, the supply pipe 22, the connecting device 23, the injector 30, and a pressure gauge 31.

### 1.2.1. Fuel Cell

Fuel cell 21 is a device that consumes the supplied hydrogen, to generate electricity by receiving the supply of air from the air hole (not shown) with the supply of hydrogen from the hydrogen tank 11. A specific configuration of the fuel cell 21 is not particularly limited, and a known one can be used.

### 1.2.2. Feed Piping

Supply pipe 22 is constituted by a pipe is a path for guiding hydrogen from the hydrogen tank 11 to the fuel cell 21. In this form, each of the hydrogen tank 11a, 11b, 11c and the fuel cell 21 is connected. Here, the pipe 22a, 22b, 22c extending from each of the hydrogen tank 11a, 11b, 11c is connected to the fuel cell 21 becomes one pipe 22d merges.

### 1.2.3. Connecting Device

Connecting device 23 is disposed at a connection portion between the hydrogen tank 11 of the supply pipe 22, together with the connection portion 17 provided in the opening and closing valve 15 of the hydrogen tank 11 described above, operates the opening and closing of the valve body 16 of the hydrogen tank 11. Connecting device 23 as can be seen from FIG. 4 has a cylindrical body 23a, the push rod 24 disposed inside the cylindrical body 23a, and a connecting portion 25 provided at the distal end of the cylindrical body 23a.

### <Push Rod>

The push rod 24 is a member which enters the hole 15a of the opening/closing valve 15 of the hydrogen-tank 11 and can press the provided valve element 16, and is rod-shaped in the present embodiment and can press the valve element 16 at its distal end. Therefore, as can be seen from FIG. 4, the push rod 24 is disposed on the inner side of the cylindrical body 23a, as shown by a straight arrow in FIG. 4 is configured to be able to protrude from the cylindrical body 23a to move in its axial direction.

### <Connection Part>

Connecting portion 25, of the cylindrical 23a, is provided at an end portion of the opposite to the connecting portion 17 provided on the on-off valve 15. The connecting portion 25 is adapted to be engaged and disengaged from the connecting portion 17 as described above. Specifically, a mechanical coupling (mechanical interface) can be cited in this form, and among them, a mount for connecting a photographing lens to a main body can be applied in a camera, and more specifically, a C-mount can be used. That is, both are connected by rotating around the axis after butting the connecting portion 17 and the connecting portion 25.

### 1.2.4. Injector

Injector 30 is disposed in the supply pipe 22 between the connecting device 23 and the fuel cell 21 (supply pipe 22d in the present embodiment), to control the supply of hydrogen to the fuel cell 21. Although a specific form of injector is not particularly limited, a flow rate adjusting valve may be mentioned.

### 1.2.5. Pressure Gauge

Pressure gauge 31 is a pressure gauge for measuring the flow path pressure of the supply pipe 22 to correspond to the internal pressure of each hydrogen tank 11 between the connecting device 23 and the injector 30 (the pressure in the pipe). Although there is no particular limitation on the specific form of the pressure gauge 31 in this embodiment, it is configured so that the obtained pressure value data can be transmitted to the control device 50.

### 1.3. Controller

The control device 50 is a device for determining whether the push rod 24 should be the waiting position and the connection position to be described later and for controlling the position of the push rod 24. Therefore, the control device 50 in this form, the push rod 24 of the connecting device 23, the injector 30, and is configured to be able to communicate with the pressure gauge 31.

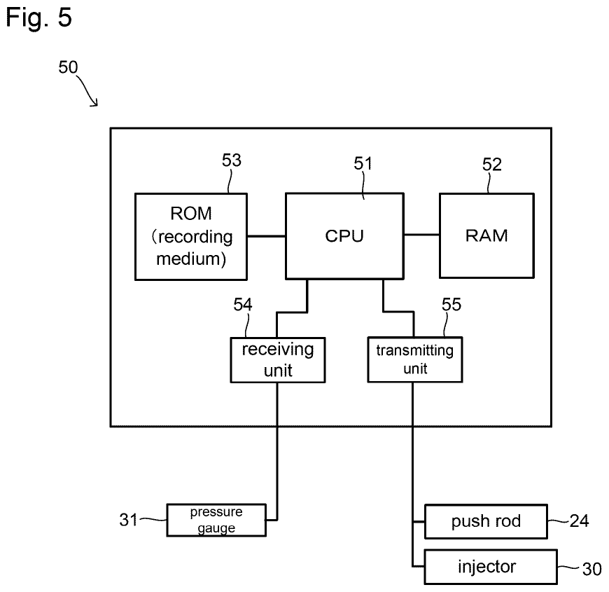

As conceptually illustrated in FIG. 5, the control unit 50 includes a Central Processing Unit (CPU) 51 that is a processor and performs operations, a RAM (Random Access Memory) 52 that functions as a working area, a ROM (Read-Only Memory) 53 that functions as a recording medium, a receiving unit 54 that is an interface that accepts information to the control unit 50 regardless of wired or wireless, and a transmitting unit 55 that is an interface that sends information to the outside from the control unit 50 regardless of wired or wireless.

Thus the control unit 50 receives information is connected to the pressure gauge 31 to the receiving unit 54, the push rod 24 to the transmitting unit 55, and the injector 30 is connected is configured to be able to transmit a signal for its operation to these.

The control device 50, a program for transmitting the signal of the operation to each device by performing arithmetic processing for hydrogen supply control to be described later is stored. In controller 50, CPU 51, RAM 52 and ROM 53 as a hardware resource and the program work together. Specifically, CPU 51 performs the desired control by executing a computer program recorded in ROM 53 in a RAM 52 that functions as a workspace. The data acquired or generated by CPU 51 is stored in RAM 52. In addition, a recording medium may be separately provided inside or outside the control device 50, and a program and various data may be recorded therein. Specific control contents will be described later.

Such a control device 50 can typically be configured by a computer.

### 2. Hydrogen Supply Control

It will be described control performed during the hydrogen supply to the fuel cell 21 from the hydrogen tank 11 in the hydrogen consumption system 10 below.

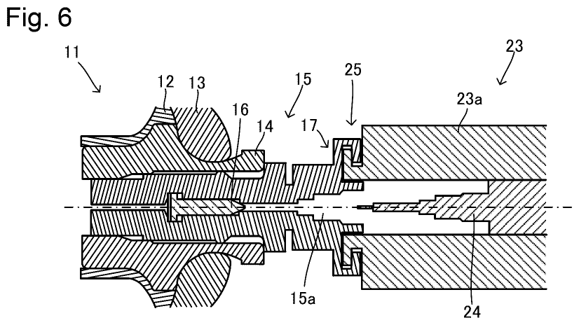

Here, as a premise, a plurality of hydrogen tanks 11 before the start of power generation is mounted on the hydrogen consumption system 10. The attachment of the hydrogen tank 11 to the hydrogen consumption system 10 may be performed, for example, as follows. That is, as shown in FIG. 4, from a condition in which the hydrogen tank 11 is detached from the hydrogen consuming apparatus 20, by butting the connecting portion 25 of the connecting device 23 of the connecting portion 17 and the hydrogen consuming apparatus 20 of the hydrogen tank 11, it is rotated around the axis. Thus, as shown in FIG. 6, the hydrogen tank 11 is connected to the hydrogen consuming apparatus 20. However, the push rod 24 at this point is not entered into the hole 15a of the on-off valve 15 is a condition immersed in the cylindrical body 23a, the on-off valve 15 because it has not pressed the valve body 16 is closed. Further, the on-off valve 15 and the supply pipe 22 in this condition is not yet communicated.

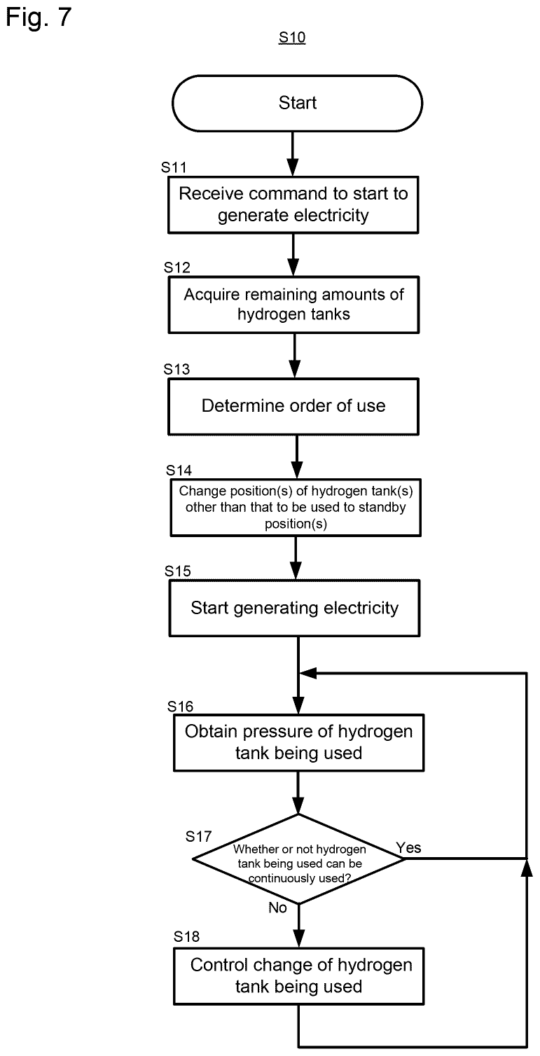

FIG. 7 shows the flow of the hydrogen-supply control S10 according to one embodiment. As can be seen from FIG. 7, the hydrogen-supply control S10 involves a process S11 to process S18. Each process is described below.

### 2.1. Directive to Start Power Generation

In the process S11 of the command of the start of power generation, the control unit 50 receives a signal triggering the start of power generation. Thus, control for power generation by the hydrogen consuming system 10 is started, the hydrogen feed control S10 is performed. Signal triggering the power generation start is not particularly limited, the user operates a power generation start switch (not shown) provided, or may be based on a program by a predetermined time or timing.

### 2.2. Acquisition of Residual Hydrogen Tank

In the process S12 of acquiring the remaining amount of the hydrogen tank, to obtain the remaining amount of all the hydrogen tanks 11 mounted. Specifically, the control device 50 controls as follows.

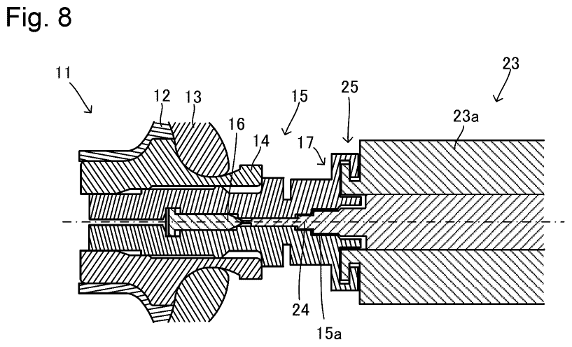

The push rod 24 is protruded from the cylindrical body 23a from the condition shown in FIG. 6 described above, the push rod 24 as shown in FIG. 8 is controlled to press the valve body 16 enters the hole 15a of the on-off valve 15. Here, the opening and closing valve 15 is opened by the valve body 16 is pressed, and further, the supply pipe 22 and the inside of the hydrogen tank 11 are brought into communication (the position of such a push rod 24 is defined as a “connection position”). Thus each pressure gauge 31 provided for each of the hydrogen tanks 11 detects the pressure corresponding to the hydrogen remaining amount of the hydrogen tank 11, to obtain the hydrogen remaining amount of each hydrogen tank 11 by the control device 50 acquires and calculates this.

### 2.3. To Determine the Order of Use

In the process S13 of determining the order of use, the control device 50 determines the order of use of the plurality of hydrogen tanks 11 based on the hydrogen residual amount of the hydrogen tank 11 obtained in the process S12. There is no particular limitation on the order in which they are arranged, and for example, the order in which the residual amount of hydrogen is small can be used.

In this form, an example in which the order of use is determined based on the residual hydrogen amount has been described, but the present disclosure is not limited thereto, and may be determined by the order of attachment to the hydrogen consumption system 10, the position, and the like.

### 2.4. Change to the Standby Position Except for the Hydrogen Tank Used.

In the process S14 of changing the other than the hydrogen tank used to the standby position, the other than the hydrogen tank 11 to be used first is changed to the standby position based on the order of use determined in the process S13.

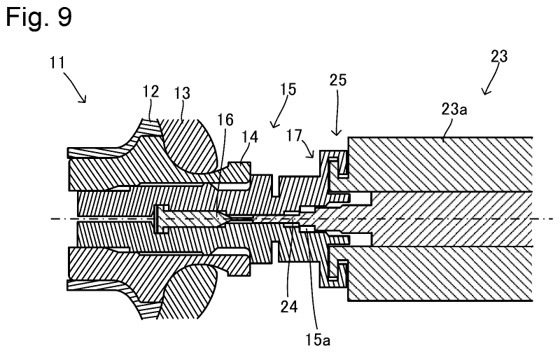

Here the standby position is a condition in which the on-off valve 15 and the supply pipe 22 while closing the valve body 16 is communicating while maintaining the airtightness in a high-pressure state. Specifically, the control device 50 to close the valve body 16 by releasing the pressing of the valve body 16 by moving the push rod 24. However, the push rod 24 as shown in FIG. 9, while projecting from the cylindrical 23a, remains inside the hole 15a of the on-off valve 15 is maintained. Thus, communication between the opening and closing valve 15 and the connecting device 23 (but closed so that the communication with the inside of the tank is shut off.) and the supply pipe 22 in a high-pressure state airtightness is maintained.

### 2.5. Start of Power Generation

In the process S15 of power generation initiation, hydrogen is supplied from the hydrogen tank 11 which is decided to be used in the process S13, and power generation is started.

Specifically, the controller 50 activates the injector 30 to deliver hydrogen from the hydrogen tank 11 determined to be used to the fuel cell 21 to generate electricity. Hydrogen tank 11 which has become a standby position in the process S14 is the communication with the supply pipe 22 is maintained at a high pressure, but the valve body 16 does not supply and flow of hydrogen because it is closed.

### 2.6. Obtaining the Pressure of the Used Tank

In the process S16 for obtaining the pressure of the hydrogen tank used, the pressure of the hydrogen tank 11 used is obtained. This monitors the remaining amount of hydrogen in the hydrogen tank 16 being used. This is performed by the pressure gauge 31 for the hydrogen tank 11 being used detects the pressure corresponding to the remaining amount of hydrogen in the hydrogen tank 11, the control device 50 acquires this. Based on the obtained pressure, the control device 50 calculates the residual hydrogen amount of the hydrogen tank 11 in use.

### 2.7. Determination of Continued Use of Hydrogen Tank

In the process S17 for determining the continuation of use of the hydrogen tank to be used, the control device 50 determines whether or not the hydrogen tank 11 is to be continuously used based on the residual hydrogen amount of the hydrogen tank 11 used obtained in the process S16 The criteria for determination are not particularly limited, and a threshold value may be set as necessary.

In this process S17, when it is determined that the hydrogen-tank 11 currently used can be used continuously, the process is turned Yes and the process S16 returns.

In this process S17, when it is determined that the currently used hydrogen-tank 11 cannot be used continuously, it is determined that the hydrogen-tank is No, and the process proceeds to the process S18.

### 2.8. Hydrogen Tank Change Control

In the process S18 of the hydrogen tank change control, the hydrogen tank 11 to be used is changed in response to the fact that the hydrogen tank 11 currently used in the process S17 was considered to be unable to be used continuously.

This change changes from the connection position to the standby position with respect to the hydrogen tank 11 which has been used so far, and also changes from the standby position to the connection position with respect to the hydrogen tank 11 to be used next based on the order of use determined in the process S13. Thus, hydrogen is supplied to the fuel cell 21 by a new use hydrogen tank 11.

After the hydrogen tank 11 to be used is changed, a process S16 is performed on the changed hydrogen tank 11, and the above is repeated.

### 2.9. Other

Hydrogen-supplying control S10 is terminated, for example, by stopping power generation. After completion, the push rod 24 is housed in the cylindrical 23a, by being returned to the status of FIG. 6, the hydrogen tank 11 is detachable from the connecting device 23.

### 3. Effect, etc.

According to the hydrogen consumption system described above, in the hydrogen consumption system in which a plurality of hydrogen tanks are mounted, even if there is a hydrogen tank that is supplying hydrogen, the hydrogen tank that is not supplying hydrogen is closed valve while communicating with the supply pipe in a high-pressure state push rod is inserted into the on-off valve, no hydrogen from the hydrogen tank used flows, it is possible to use the hydrogen tank properly.

Further, the one hydrogen tank and the connection position, in the case where all other hydrogen tanks and the standby position, it is possible to use one by one in a plurality of hydrogen tanks, the exchange of the hydrogen tank 11 the hydrogen remaining amount is reduced it is also possible to perform one by one. In addition, in this case, since the hydrogen tank can be used one by one, it is possible to minimize leakage by suppressing a large amount of leakage from a plurality of hydrogen tanks even when, for example, leakage of hydrogen occurs.

### REFERENCE SIGNS LIST

10. . . . Hydrogen consumption system, 11 . . . hydrogen tank, 15 . . . on-off valve, 16 . . . valving element, 17 . . . connection, 20 . . . hydrogen consumption apparatus, 21 . . . fuel cell, 22 . . . supply piping, 23 . . . connection device, 24 . . . push rod, 25 . . . connection, 30 . . . injector, 31 . . . pressure gauge, 50 . . . control device

What is claimed is:

1. A hydrogen consumption system comprising:
a plurality of attachable and detachable hydrogen tanks;
a fuel cell to which hydrogen in any of the hydrogen tanks is to be supplied, the fuel cell consuming the hydrogen;
supply piping connecting the hydrogen tanks and the fuel cell, the hydrogen being flowable in the supply piping; and
a control device, wherein
the hydrogen tanks each have an on-off valve at a connection portion with the supply piping,
the supply piping is provided with push rods at respective connection portions with the hydrogen tanks,
the control device sorts a plurality of the hydrogen tanks, and determines to supply the hydrogen to at least one of the hydrogen tanks, and not to supply the hydrogen to rest of the hydrogen tanks,
the control device moves the push rod corresponding to said at least one hydrogen tank toward the on-off valve of said at least one hydrogen tank so as to open the valve of said at least one hydrogen tank, and to be at a connection position so that the hydrogen can be supplied to the supply piping, and
the control device moves the push rod(s) corresponding to the rest of the hydrogen tanks to be at (a) standby position(s), so that the on-off valve(s) of the rest of the hydrogen tank(s) is/are closed whereas airtightness in the on-off valve(s) of the rest of the hydrogen tank(s) and the supply piping is maintained in a state where the on-off valve(s) of the rest of the hydrogen tank(s) and the supply piping are connected with each other.

2. The hydrogen consumption system according to claim 1, wherein
the control device acquires a remaining amount of the hydrogen of each of a plurality of the hydrogen tanks with sensors, and
in said sorting and determining, the control device sets the push rod corresponding to only one of a plurality of the hydrogen tanks of a smallest remaining amount of the hydrogen to be at the connection position, and sets the push rod(s) corresponding to rest of hydrogen tank(s) to be at the standby position(s).
